(19) United States
(12) Patent Application Publication
(10) Pub. No.: US 2002/0073314 A1
(43) Pub. Date: Jun. 13, 2002

(54) System and method for identifying lost electronic devices

(75) Inventor: Rashmi Bhat, Austin, TX (US)

Correspondence Address: Edmond A. DeFrank, 20145 Via Medici, Northridge, CA, 91326, US

(73) Assignee: International Business Machines Corporation

(21) Appl. No.: 09/732,252

(22) Filed: Dec. 7, 2000

(51) Int. Cl. G06F 1/24; G06F 11/30

(52) U.S. Cl. 713/167; 713/201

(57) ABSTRACT

The present invention is embodied in a system and method for providing ownership identification information of lost electronic devices, such as portable computers, personal data assistants (PDAs) and/or mobile telephones. In general, the present invention is an identification and security system for portable computers, PDAs, mobile telephones or any storage based electronic device to easily allow ownership identification indicia of the device to be easily displayed when the device is lost. In addition, the system securely protects data located on the electronic devices. Namely, an information button can be used to display ownership indicia on the display screen of the electronic device when the information button is selected. This allows the graphical user interface (GUI) of the display to present ownership information, such as the owner's name, contact telephone number, return address, Internet World Wide Web (WWW) pages, etc.

### BACKGROUND OF THE INVENTION

1. Field of the Invention

The present invention relates in general to portable computers, mobile telephones and personal data assistants and in particular to a system and method for identifying lost electronic devices, such as portable computers, personal data assistants and/or mobile telephones.

2. Related Art

Electronic devices are becoming more and more ubiquitous because they help users manage their busy schedules, as well as communicate with the world. For example, portable computers, such as notebook or laptop computers, personal data assistants (PDAs) and mobile telephones are becoming necessities for many. Notebook or laptop computers are very popular because they are extremely lightweight personal computers that can easily in a briefcase for the mobile businessperson. Aside from size, the principal difference between a notebook or laptop computer and a personal computer is the display screen. Portable computers typically use flat-panel technologies, which are lightweight and non-bulky.

A PDA is a handheld device that allows users to access information, keep track of their busy schedules, and communicate with others. A typical PDA can function as a mobile or cellular phone, fax sender, and personal organizer. Recently, many of the major announcements revolve around wireless connectivity for a PDA. It is very important for today's mobile professional to able to access information from anywhere in the world. Similar to the portable computer, PDAs are very popular because they are designed to be portable and small. Currently, PDA manufactures strive to make PDAs as portable and small as possible. Fitting easily into a wallet, small purse, or shirt pocket, the newest PDAs can travel anywhere in the world. Therefore, people do not think twice about taking their portable computer, PDA or mobile telephone anywhere.

However, although there are many advantages to having portable-sized devices, they are susceptible to being easily lost or misplaced since these devices are very small. In addition, since these devices are very popular and are in high demand, they are likely targets for thieves. Further, once these portable devices are in the possession of another, sensitive data or confidential information on the portable device can be accessed.

Therefore, what is needed is a system and method for identifying lost electronic devices, such as portable computers, personal data assistants and/or mobile telephones. What is further needed is a system and method that allows easy and quick access to ownership indicia of electronic devices, which is particularly useful when if the devices are lost, while providing protected access to data stored on the electronic device.

### SUMMARY OF THE INVENTION

To overcome the limitations in the prior art described above, and to overcome other limitations that will become apparent upon reading and understanding the present specification, the present invention is embodied in a system and method for providing ownership identification information of lost electronic devices, such as portable computers, personal data assistants (PDAs) and/or mobile telephones.

In general, the present invention is an identification and security system for portable computers, PDAs, mobile telephones or any storage based electronic device to allow ownership identification indicia of the device to be easily displayed when the device is lost. In addition, the system securely protects data located on the electronic devices. Namely, an information button can be implemented to display ownership indicia on the display screen of the electronic device when the information button is selected. This allows the graphical user interface (GUI) of the display to present ownership information, such as the owner's name, contact telephone number, return address, Internet World Wide Web (WWW) pages, etc.

In particular, the information button can be clearly located on the electronic device. The information button accesses predefined data stored on the electronic device to allow the ownership indicia to be displayed on the electronic device when it's selected. A security module can be included to provide protected access to data stored on the electronic device by locking out unauthorized access to the data. In addition, if the electronic device has a network communications device, the electronic device can access a global database for storing, retrieving and updating ownership identification information for each registered user of the present invention.

The present invention as well as a more complete understanding thereof will be made apparent from a study of the following detailed description of the invention in connection with the accompanying drawings and appended claims.

### BRIEF DESCRIPTION OF THE DRAWINGS

Referring now to the drawings in which like reference numbers represent corresponding parts throughout:

FIG. 1 is a general block diagram showing an overview of the present invention.

FIGS. 2A and 2B are pictorial diagrams showing the identification and security system of the present invention on example electronic devices.

FIG. 3 is a detailed flow diagram illustrating a working example of the present invention.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. General Overview of the Components

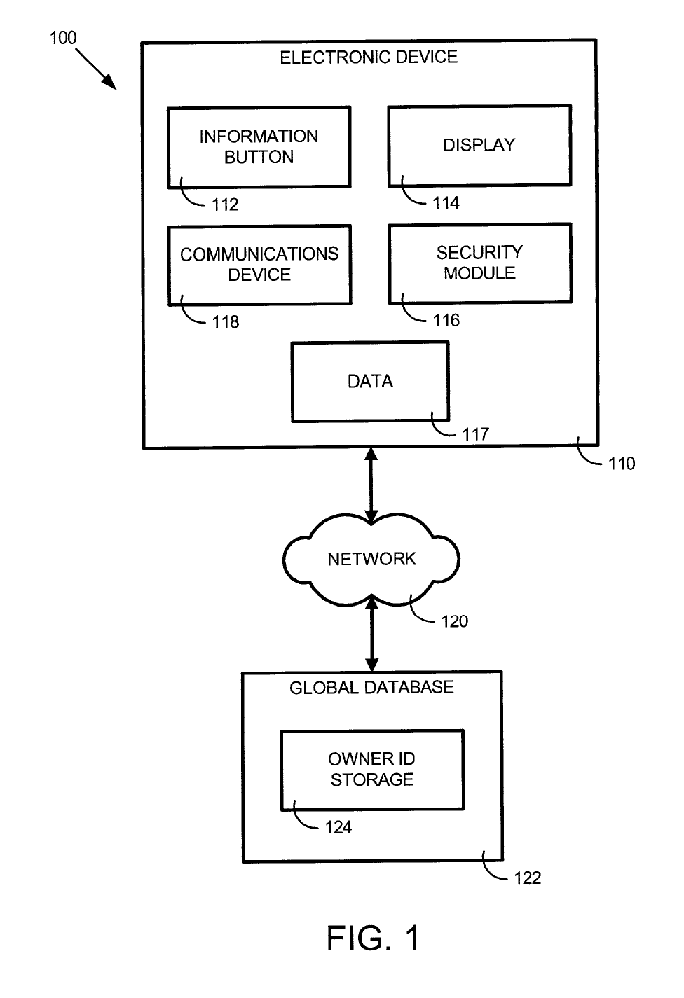

FIG. 1 is a general pictorial block diagram showing an overview of the present invention. In general, the system 100 of the present invention includes an identification and security system 112 for any suitable electronic device 110 with storage capabilities, such as portable computers, PDAs, mobile telephones, to allow ownership identification indicia of the electronic device 110 to be easily displayed on a display 114 when the device 110 is lost, misplaced or stolen.

Specifically, the electronic device includes an information mechanism 112, such as an information button clearly located on the electronic device 110. The information mechanism 112 is adapted to display the ownership indicia on the display 114 of the electronic device when it's selected and will be discussed in detail below. The owner can configure the information mechanism 112 during the initial registration process of the electronic device.

Configuration includes entering the owner's contact information in case the electronic device is lost or stolen, as well as configuring security options with a security module 116 and defining a password. The security module 116 provides protected access to data stored 117 on the electronic device 110 by locking out unauthorized access to the data 117. In addition, a network communications device 118 that is connected to a network 120, such as the Internet, can be used to access a global database 122 for storing, retrieving and updating ownership identification information 124 for each registered user of the system 110.

II. Details of the Components and Operation

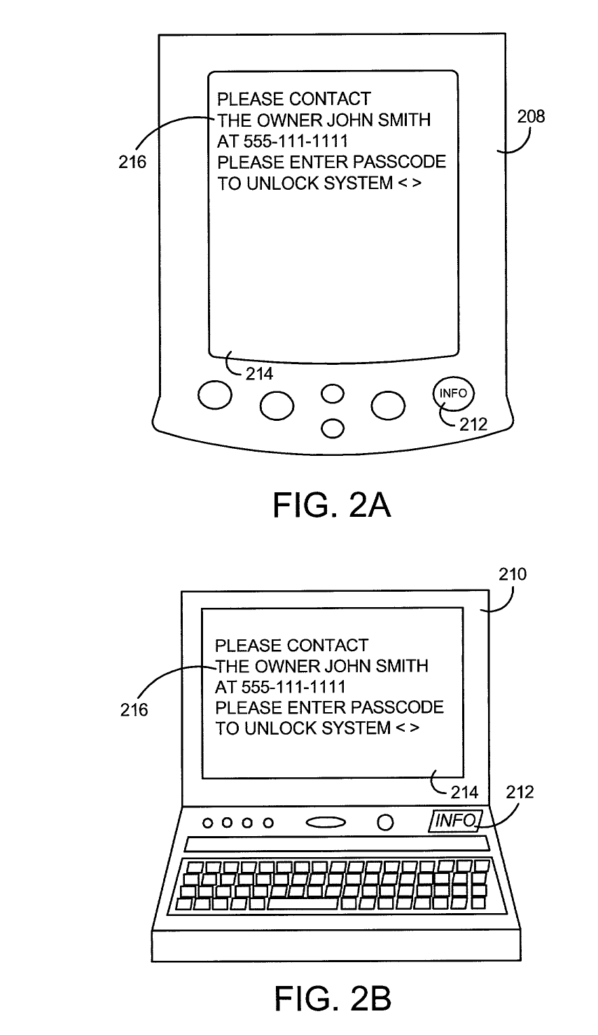

FIGS. 2A and 2B are pictorial diagrams showing the identification and security system of the present invention on example electronic devices. FIG. 2A shows the present invention implemented on a PDA 208. The PDA 208 is preferably a handheld device that allows users to access information, keep track of their busy schedules, and communicate with others. The PDA can also function as a mobile or cellular phone, fax sender, and personal organizer. FIG. 2B shows the present invention implemented on a portable computer 210, such as a notebook or a laptop computer.

Both the PDA and portable computer 208, 210 include an information button 212 that is functionally similar to information button 112 of FIG. 1. As shown in FIGS. 2A and 2B, the information button 112 is clearly and conspicuously located and marked on the electronic devices 208, 210. The information button 112 is electronically coupled to the security module 116 of FIG. 1 (not shown in FIGS. 2A and 2B) in any suitable manner.

The information button 212 can be software or hardware controlled. For example, provided the owner configured the information button 112 during the initial registration process of the electronic device, when the information button 212 is selected, a software driven module (for instance, a portion of the operating system) can be launched or a hardware microchip can be initiated that automatically accesses pre-stored ownership indicia of the electronic device. The ownership indicia can be stored locally on the electronic device. The security module 116 is also launched when the information button 212 is selected.

The security module 116 can be implemented as a software module or a firmware device for protecting data located on the electronic devices 208, 210. Preferably, the security module 116 is coupled to the operating system and automatically locks out unauthorized access to the electronic devices 208, 210 by requiring username and/or password information every time the electronic devices 208, 210 are started or when the information button 212 is selected. The owner can configure the username and/or password information during initial registration and setup of the electronic devices 208, 210.

In operation, when the information button 212 is depressed or selected, the security module 116 is accessed and allows only ownership identification indicia 216 of the devices 208, 210 to be presented on the display screen 214 of the electronic devices 208, 210. The ownership indicia 216 could include information or instructions for returning the electronic device 208, 210, such as the owner's name, contact telephone number, return address, Internet World Wide Web (WWW) pages, etc.

III. Working Example

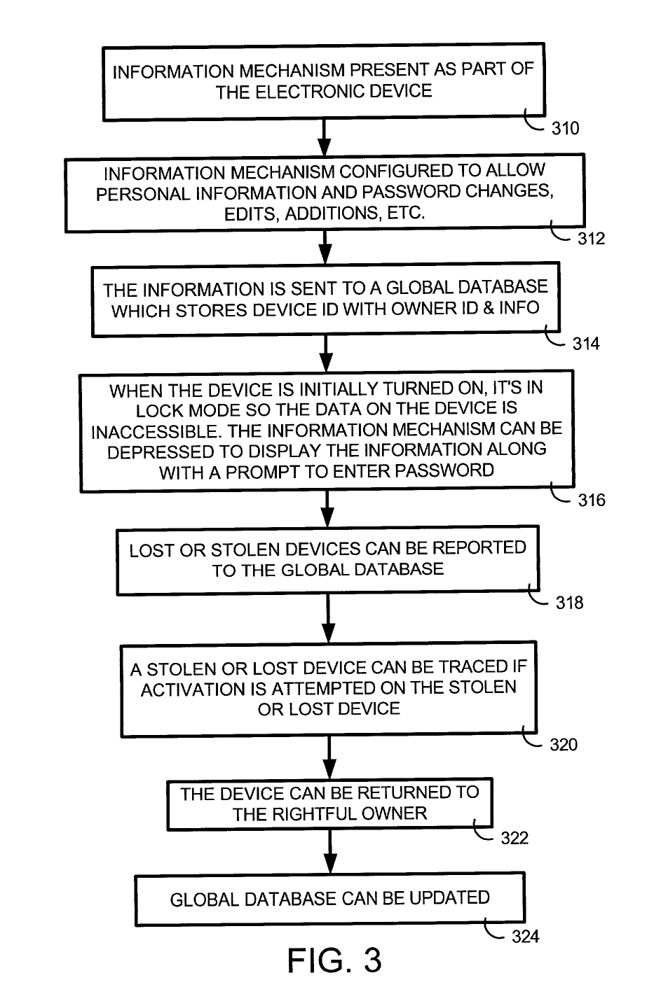

FIG. 3 is a detailed flow diagram illustrating a working example of the present invention. In one example, if the information mechanism is present as part of the electronic device 208 of FIG. 2, the electronic device 208 is protected 310 after the owner initiates the system. The information mechanism can then be accessed for initially configuring personal information. Subsequently, the information mechanism can be accessed for making password changes, edits, additions, etc. to the information 312. The information can also be sent to the global database 122 of FIG. 1, which stores a unique serial number or device ID of the electronic device 208 along with owner identification information. Each owner's identification information is associated with each unique serial number 314.

When the electronic device 208 is initially turned on, the security module creates a lock mode so that the data on the electronic device is inaccessible, as discussed above. When the information mechanism is depressed, the owner's information along with a prompt to enter password is displayed, while the security module secures data on device 316. In addition, if a valid password is entered, changes to the previously stored information, as discussed above, can be made. Consequently, if the device is lost, the data on the device cannot be accessed, but the owner can be contacted.

Next, the owner can report lost or stolen devices to the global database 318. This allows tracing via the unique serial number of stolen or lost devices if activation of an affiliated service provider of the global database is attempted on the stolen or lost device 320. If the lost or stolen device is reported and the unique serial number is matched with the owner's information, the device can be returned to the rightful owner 322. The global database can be periodically updated with current information or the history of the device 324.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An identification and security system for displaying ownership identification information on a display of an electronic device, comprising:
an information mechanism that displays the ownership identification information on the display of the electronic device when selected; and
a security module that provides protected access to data stored on the electronic device when the information mechanism is activated.

2. The identification and security system of claim 1, further comprising a communications device coupled to a network for accessing a global database.

3. The identification and security system of claim 2, wherein the global database stores, retrieves and updates ownership identification information for each registered user of the identification and security system.

4. The identification and security system of claim 3, wherein the global database stores a unique serial number of the electronic device along with the ownership identification information so that each owner's identification information is associated with each unique serial number.

5. The identification and security system of claim 4, wherein the global database includes a tracer to locate a lost or stolen electronic device if the lost or stolen device communicates with an affiliated Internet service provider.

6. The identification and security system of claim 1, wherein the ownership identification information includes at least one of instructions for returning the electronic device or information relating to the owner.

7. The identification and security system of claim 6, wherein the ownership identification information relating to the owner includes at least one of the owner's name, contact telephone number, return address or Internet World Wide Web site.

8. The identification and security system of claim 1, wherein the electronic device is a portable computer.

9. The identification and security system of claim 1, wherein the electronic device is a personal data assistant.

10. A method for providing ownership identification information of lost electronic devices, comprising:
displaying the ownership identification information on the display of the electronic device when selecting an information mechanism;
providing protected access to data stored on the electronic device when the information mechanism is activated; and
storing, retrieving and updating the ownership identification information on a global database.

11. The method of claim 10, wherein the global database stores a unique serial number of the electronic device along with ownership identification information so that each owner's identification information is associated with each unique serial number.

12. The method of claim 11, further comprising tracing lost or stolen electronic device if the lost or stolen device communicates with an affiliated Internet service provider.

13. The method of claim 10, wherein the ownership identification information includes at least one of instructions for returning the electronic device or information relating to the owner.

14. The method of claim 13, wherein the information relating to the owner includes at least one of the owner's name, contact telephone number, return address or Internet World Wide Web site.

15. The method of claim 10, wherein the electronic device is a portable computer.

16. The method of claim 10, wherein the electronic device is a personal data assistant.

17. An identification and security system for displaying ownership identification information on a display of an electronic device, comprising an information button easily accessible for providing the ownership identification information on the display of the electronic device when selected.

18. The identification and security system of claim 17, further comprising a security module that provides protected access to data stored on the electronic device when the information button is activated and a communications device coupled to a network for accessing a global database, wherein the global database stores, retrieves and updates ownership identification information for each registered user of the identification and security system.

19. The identification and security system of claim 18, wherein the global database stores a unique serial number of the electronic device along with the ownership identification information so that each owner's identification information is associated with each unique serial number.

20. The identification and security system of claim 19, wherein the global database includes a tracer to locate a lost or stolen electronic device if the lost or stolen device communicates with an affiliated Internet service provider.
